(19) United States
(12) Patent Application Publication
(10) Pub. No.: US 2010/0059431 A1
(43) Pub. Date: Mar. 11, 2010

(54) WATER IONIZER CAPABLE OF RECOGNIZING GENUINE FILTER AND WATER PURIFYING FILTER USED THEREIN

(76) Inventor: Gyu-Dai Cho, Gyeonggi-do (KR)

Correspondence Address: F. CHAU & ASSOCIATES, LLC, 130 WOODBURY ROAD, WOODBURY, NY, 11797, US

(21) Appl. No.: 12/554,308

(22) Filed: Sep. 4, 2009

(30) Foreign Application Priority Data
Sep. 9, 2008 (KR) 10-2008-0088940

(51) Int. Cl. B01D 35/153

(52) U.S. Cl. 210/235

(57) ABSTRACT

Provided is a water ionizer which can detect a detection target installed at a predetermined position of a genuine filter to recognize that a genuine filter is loaded, which makes it possible to raise the reliability of the water ionizer and to extend the lifespan of the water ionizer. The water ionizer capable of recognizing a genuine filter, which has a water purifying filter for filtering foreign matters contained in original water, includes a sensor that is operated by a detection target attached to a proper position of a filter case of the water purifying filter; and a controller that checks whether a genuine water purifying filter is loaded or not, based on the sensing result of the sensor, and then stops the operation of the water ionizer when a genuine water purifying filter is not loaded. The water ionizer may further include a guide unit that guides the water purifying filter such that the water purifying filter is loaded at a predetermined position of the water ionizer. The detection target may be a magnet sheet composed of a permanent magnet, and the sensor may include a reed switch which is turned on/off by an external magnetic field generated by the magnet sheet. The sensor may include a photo coupler which detects that emitted light is delivered to or shielded by the filter case of the water purifying filter.

### CROSS-REFERENCE TO RELATED APPLICATION

This application claims priority to and the benefit of Korean Patent Application No. 2008-0088940, filed Sep. 9, 2008, the disclosure of which is incorporated herein by reference in its entirety.

### BACKGROUND

1. Field of the Invention

The present invention relates to a water ionizer capable of recognizing a genuine filter and a water purifying filter used therein, and more specifically, to a water ionizer which can detect a detection target installed at a predetermined position of a genuine filter case to recognize that a genuine filter is loaded and a water purifying filter used therein.

2. Discussion of Related Art

In general, a variety of environmental pollutions caused by industrialization are being raised as a serious social problem. Among the variety of environmental pollutions such as air pollution, soil pollution, and water pollution, the pollution of natural waters such as river waters, seawaters, or mineral waters is being considered to be a serious problem which restricts the use of tap water as drinking water. Therefore, in homes and public places such as schools, work places, or government and public offices, more and more cold and hot water purifiers are being installed, so that people can select and drink cold or hot water purified through the cold and hot water purifiers instead of tap water, according to their tastes.

The present applicant has developed a water ionizer providing alkali- or acid-ionized water, and has placed the water ionizer on the market. FIG. 1 is a diagram showing the structure of a conventional cold and hot water purifying ionizer.

As shown in FIG. 1, the conventional cold and hot water purifying ionizer includes a filter 10 that is installed in a supply tube 11 to filter foreign matters, which are contained in water supplied from a water pipe connected to the water ionizer and supplied together with the water, a hot and cold water valve 20 that can separate the purified water into hot water and cold water and selectively supply the water through the supply tube connected to the filter 10, a cooling device 50 that can reduce the temperature of the water supplied through the valve 20 below a predetermined value, a pressure detecting device 30 that detects the pressure of the water supplied through the supply tube 11, a typical water purifying device for purifying water supplied through an evaporator 51, an electronic valve (solenoid valve) 40 that is installed at the front of the cooling device 50 to bypass water passing through the valve 20 when a large amount of water is supplied to the evaporator 51 of the cooling device 50, a bypass tube 60 through which the water bypassed by the electronic valve 40 is supplied to the water purifying device 70, a temperature detector 80 that detects the temperature of the water purified by the water purifying device 70, and an electrolytic bath 90 that electrolyzes the water supplied through the temperature detector 80 and then ionizes the electrolyzed water into alkali or acid water, and a controller 100 that controls the overall operations of the water ionizer.

In the above-described structure, the cooling device 50 includes the evaporator 51 which evaporates heat to reduce the temperature of supplied water below a predetermined value, a compressor 52 which compresses refrigerant such that heat can be evaporated through the evaporator 51, a condenser 53 which condenses the evaporated refrigerant such that the refrigerant can be compressed in the compressor 52, a dryer 54 which filters water and foreign matters contained in the refrigerant liquefied in the condenser 53, a decompression capillary tube 55 which constantly maintains the pressure of the refrigerant supplied through the dryer 54, and a refrigerant tube 56 connecting the respective blocks.

The water purifying device 70 purifies water using a typical water purifying method. As the water purifying device 70, either a water purifying device which purifies water through a single filter or a water purifying device which purifies water through an osmotic pressure method may be used. Further, the filter 10 serves to filter foreign matters contained in tap water supplied from a water pipe which is directly connected to the filter 10. If necessary, two or more filters may be used.

However, since a genuine filter used as the filter 10 is very expensive, it is highly likely that people easily fall into temptation to use a fake filter of which the efficiency or lifespan is considerably inferior to the genuine filter. When such a fake filter is used, it may degrade the reliability of the water ionizer.

### SUMMARY OF THE INVENTION

The present invention is directed to a water ionizer which can detect a detection target installed at a predetermined position of a genuine filter to recognize that a genuine filter is loaded, which makes it possible to raise the reliability of the water ionizer and to extend the lifespan of the water ionizer.

The present invention is also directed to a water purifying filter used in the water ionizer.

The additional purposes of the present invention will be understood by the following descriptions and exemplary embodiments of the present invention.

One aspect of the present invention provides a water ionizer capable of recognizing a genuine filter, which has a water purifying filter for filtering foreign matters contained in original water, including a sensor that is operated by a detection target attached to a proper position of a filter case of the water purifying filter; and a controller that checks whether a genuine water purifying filter is loaded or not, based on the sensing result of the sensor, and then stops the operation of the water ionizer when a genuine water purifying filter is not loaded.

The water ionizer may further include a guide unit that guides the water purifying filter such that the water purifying filter is loaded at a predetermined position of the water ionizer.

The detection target may be a magnet sheet composed of a permanent magnet, and the sensor may include a reed switch which is turned on/off by an external magnetic field generated by the magnet sheet. The sensor may include a photo coupler which detects that emitted light is delivered to or shielded by the filter case of the water purifying filter.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a diagram showing the structure of a conventional cold and hot water purifying ionizer;

FIG. 2 is a diagram for explaining the principle of genuine filter recognition of a water ionizer capable of recognizing a genuine filter according to an exemplary embodiment of the present invention;

FIG. 3 is a diagram for explaining the principle of genuine filter recognition of a water ionizer capable of recognizing a genuine filter according to another exemplary embodiment of the present invention;

FIG. 4 is a diagram for explaining the principle of genuine filter recognition of a water ionizer capable of recognizing a genuine filter according to still another exemplary embodiment of the present invention; and

FIG. 5 is a block diagram showing the electrical configuration of the water ionizer capable of recognizing a genuine filter according to the present invention.

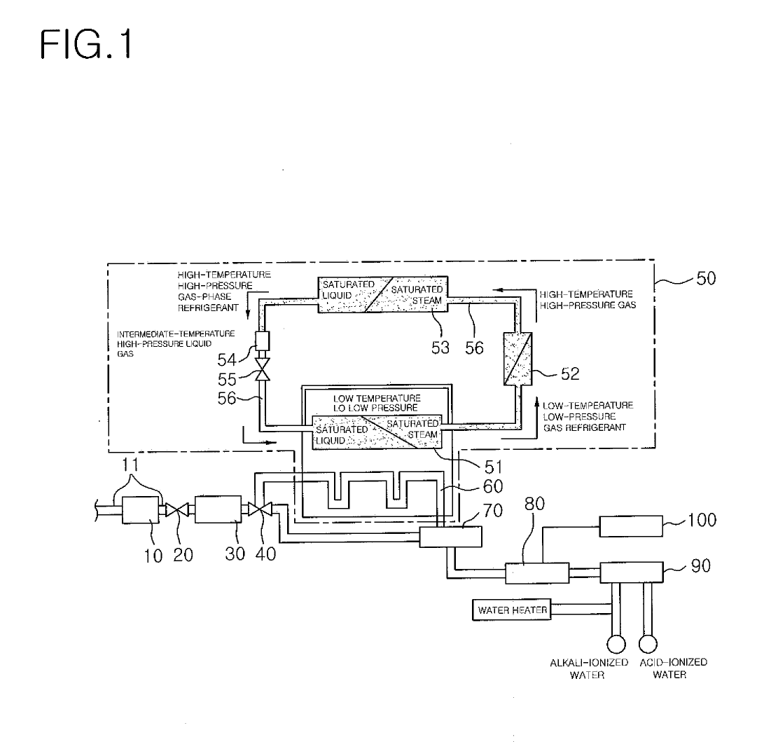

### DETAILED DESCRIPTION OF EXEMPLARY EMBODIMENTS

Hereinafter, a water ionizer capable of recognizing a genuine filter and a water purifying filter used therein according to the present invention will be described in detail with reference to the accompanying drawings.

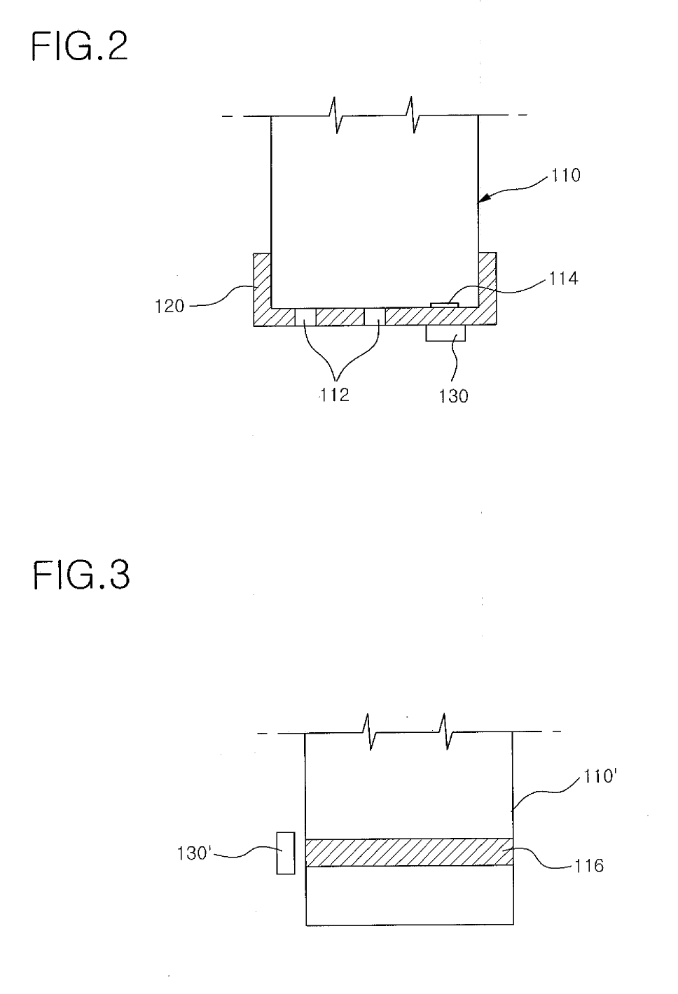

FIG. 2 is a diagram for explaining the principle of genuine filter recognition of a water ionizer capable of recognizing a genuine filter according to an exemplary embodiment of the present invention.

As shown in FIG. 2, a structure for recognizing genuine filter in the water ionizer capable of recognizing a genuine filter according to the present invention includes a magnet sheet 114 which is attached to a proper position of a filter case 110 of a genuine filter, for example, the bottom surface of the filter case 110, the magnet sheet 114 being composed of a permanent magnet generating a magnetic field, or preferably a thin plate, and a reed switch 130 which is attached to a filter receiving portion 120 of the water ionizer and is operated by the magnetic field generated from the magnet sheet 114 of a genuine filter.

In the above-described structure, reference numeral 112 represents a matching protrusion which guides the magnet sheet 114 of the genuine filter such that the magnet filter 114 is accurately received on the reed switch 130 of the filter receiving portion 110. At a corresponding position of the bottom surface of the filter receiving portion 120, a matching groove is formed.

The above-described reed switch 130 includes two reeds formed of a magnetic alloy and provided in the middle of a glass tube. The reeds overlap each other in such a state that free ends (leading ends) thereof are separated from each other. When a genuine filter having the magnet sheet 114 installed thereon is loaded at the right position, an external magnetic field generated from the magnet sheet 114 causes the leading ends of the two reeds to attract each other and to be short-circuited. A controller, which will be described below, can detect the voltages of both ends of a resistor connected to the reeds and thus recognize that the genuine filter is loaded.

FIG. 3 is a diagram for explaining the principle of genuine filter recognition of a water ionizer capable of recognizing a genuine filter according to another exemplary embodiment of the present invention.

In this exemplary embodiment, a ring-shaped magnetic sheet 116 is attached to the outer circumferential surface of a filter case 110′ of a genuine filter, and a reed switch 130′ is installed at the same height, as shown in FIG. 3. In this case, since a component for matching, that is, a matching protrusion is not required unlike the structure shown in FIG. 2, a space can not only be saved, but a degree of freedom in design can also increase. Further, since a free space is provided between the magnet sheet 116 and the reed switch 130′, a distance between the magnet sheet 116 and the reed switch 130′ can be reduced, which makes it possible to remarkably increase a recognition rate of genuine filters even at a small magnetic field.

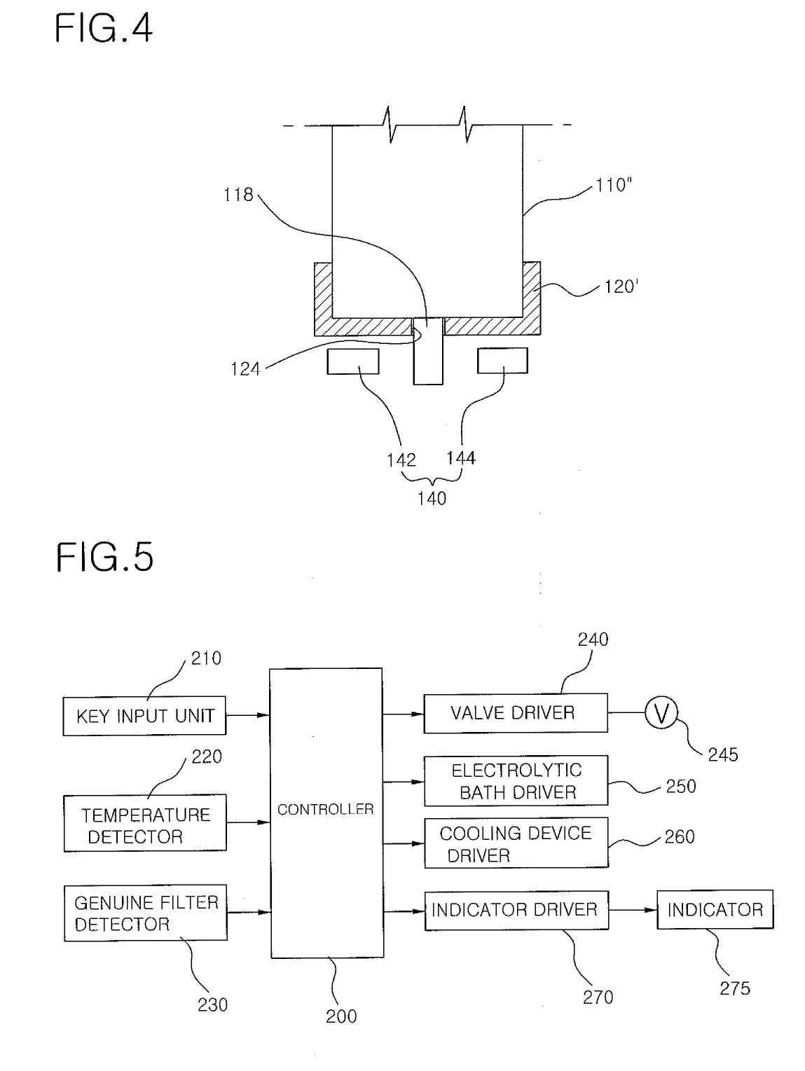

FIG. 4 is a diagram for explaining the principle of genuine filter recognition of a water ionizer capable of recognizing a genuine filter according to still another exemplary embodiment of the present invention.

In this exemplary embodiment, a light shading protrusion 118 having a predetermined length (height) is attached to a proper position of a filter case 110″, for example, a central position of the bottom surface of the filter case 110″, a protrusion through-hole 124 is formed at a corresponding position of a filter receiving portion 120′, and a pair of photo couplers 140 are installed under the filter receiving portion 120′ with the protrusion through-hole 124 interposed therebetween, as shown in FIG. 4.

In the above-described structure, the photo couplers 140 may include a light emitting device 142, for example, a light emitting diode and a light receiving device 144 receiving light emitted from the light emitting device 142, for example, a photo transistor. The light shielding protrusion 118 is formed so as to be larger than the depth of the protrusion through-hole 124. When a genuine filter is loaded, light emitted from the light emitting device 142 is shielded by the light shielding protrusion 124 so as not to be transmitted to the light receiving device 144. Accordingly, the water ionizer can recognize that the genuine filter is loaded. On the contrary, when a fake filter is loaded, light emitted from the light emitting device 142 is transmitted to the light receiving device 144 such that the controller recognizes that a filter is not loaded currently or a fake filter is loaded.

FIG. 5 is a block diagram showing the electrical configuration of the water ionizer capable of recognizing a genuine filter according to the present invention.

As shown in FIG. 5, the electrical configuration of the water ionizer capable of recognizing a genuine filter according to the present invention may include a key input unit 210 which is used for selecting a variety of functions required for operations of the water ionizer or inputting settings, a temperature detector 220 which detects the temperature of purified water, a genuine filter detector 230 which detects whether a genuine filter is loaded or not, a valve driver 240 which drives a variety of solenoid valves 245 provided in the water ionizer, an electrolytic bath driver 250 which drives an electrolytic bath for electrolyzing neural water, a cooling device driver 260 which drives a cooling device for cooling clean water, an indicator 275 which indicates various operation states of the water ionizer, an indicator driver 270 which drives the indicator 275, and a controller 200 which collectively controls the respective drivers on the basis of the contents input through the key input unit 210 and the values detected by the respective detectors 220 and 230.

In the above-described configuration, the genuine filter detector 230 may include the reed switch 130 or 130′ and the peripheral circuits thereof, and the controller 200 may include a microcomputer which is operated in a software manner by a program. When a control target is simple, the controller 200 may be implemented as a hardware component. When the genuine filter detector 230 is implemented as a reed switch, the genuine filter detector 230 may include the reed switch 130 or 130′ and the peripheral circuit elements thereof (for example, a resistor and so on). When the genuine filter detector 230 is implemented as photo couplers, the genuine filter detector 230 may include the photo couplers 140 and the peripheral circuits.

In the water ionizer having the above-described configuration according to the present invention, when the controller 200 judges that a genuine filter is not loaded, that is, when the reed switch 130 or 130′ is turned off in the case of a reed switch type or the light receiving device 144 of the photo couplers 140 is turned on in the case of a photo coupler type, the controller 200 stops the operation of the water ionizer, and controls the indicator driver 270 to inform a user that a genuine filter is not used, through the indicator 275.

The water ionizer capable of recognizing a genuine filter and the water purifying filter used therein according to the present invention are not limited to the above-described exemplary embodiments, and various changes may be made therein without departing from the spirit and scope of the present invention. For example, instead of the magnet sheet, a metal sheet may be attached to the filter case in the above-described exemplary embodiments. Further, an electrostatic capacity sensor may be installed instead of the reed switch, in order to detect whether a genuine filter is loaded or not. In addition, the reed switch may be implemented in a normal close type, not in such a normal open type as described above, and even the photo couplers may be implemented in a reflection type, not in such a transmission type as described above. The present invention can be applied to water ionizers of cold or hot water or water ionizers having a function of purifying cold and hot water as well as simple water ionizers. Therefore, a term of ‘ionizer’ used in claims is a general term for those ionizers.

According to a water ionizer capable of recognizing a genuine filter and a water purifying filter used therein, a detection target is installed at a predetermined position of the genuine filter to recognize that the genuine filter is loaded, and thus it is possible to raise the reliability of the water ionizer and extend the lifespan of the water ionizer.

While exemplary embodiments have been disclosed herein, it should be understood that other variations may be possible. Such variations are not to be regarded as a departure from the spirit and scope of exemplary embodiments of the present application, and all such modifications as would be obvious to one skilled in the art are intended to be included within the scope of the following claims.

What is claimed is:

1. A water ionizer capable of recognizing a genuine filter, which has a water purifying filter for filtering foreign matters contained in original water, comprising:
a sensor that is operated by a detection target attached to a proper position of a filter case of the water purifying filter; and
a controller configured to check whether a genuine water purifying filter is loaded or not, based on the sensing result of the sensor, and then stop the operation of the water ionizer when a genuine water purifying filter is not loaded.

2. The water ionizer according to claim 1 further comprising:
a guide unit configured to guide the water purifying filter such that the water purifying filter is loaded at a predetermined position of the water ionizer.

3. The water ionizer according to claim 2, wherein the detection target is a magnet sheet composed of a permanent magnet, and the sensor includes a reed switch which is turned on/off by an external magnetic field generated by the magnet sheet.

4. The water ionizer according to claim 2, wherein the sensor includes a photo coupler configured to detect that emitted light is delivered to or shielded by the filter case of the water purifying filter.

5. A water purifying filter used in the water ionizer according to claim 1.

6. A water purifying filter used in the water ionizer according to claim 2.

7. A water purifying filter used in the water ionizer according to claim 3.

8. A water purifying filter used in the water ionizer according to claim 4.
